(19) United States
(12) Patent Application Publication
(10) Pub. No.: US 2006/0007899 A1
(43) Pub. Date: Jan. 12, 2006

(54) System and method for monitoring and managing local area network activity

(75) Inventor: Russell William White, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, LP

(21) Appl. No.: 10/867,279

(22) Filed: Jun. 14, 2004

(51) Int. Cl. H04Q 7/24

(52) U.S. Cl. 370/338

(57) ABSTRACT

A system and method are disclosed for monitoring and managing local area network activity. A system incorporating teachings of the present disclosure may include a housing component that at least partially defines an enclosure. A processor may be located within the enclosure, and an interface may assist in communicatively coupling the processor to a node of a wireline network. The system my also include a wireless local area networking module communicatively coupled to a memory and configured to communicate within a local coverage area using a proximal wireless protocol. The memory may store a messaging file that includes instructions to direct a wireless telephone processor to send a wireless messaging service message configured for delivery via a wide area wireless network to the wireless local area networking module using the proximal wireless protocol. The system may also include a message forwarding engine configured to output information representing the wireless messaging service message via the interface to the wireline network.

### FIELD OF THE INVENTION

The present disclosure relates generally to communication services, and more specifically to a system and method for monitoring and managing local area network activity.

### BACKGROUND

It appears that consumers are beginning to recognize the value of home networking. This may be due in part to the seemingly ever-increasing number of “smart” consumer electronic devices sold for in-home use. Whatever the cause, many of the now networked consumers have elected to create their home networks using solutions based on wireless radio frequency (RF) technologies.

An RF-based home network may take many forms. One network may have an ad-hoc or a peer-to-peer schema, while another may employ a hub-based schema. Ad-hoc wireless networks usually consist of several computing devices, each equipped with a wireless transceiver. The individual devices communicate directly with one another wirelessly. Ad-hoc networks may be employed to share files or printers. Wireless networks designed to utilize a hub-based schema often have an access point acting as the hub and providing a central point of connectivity for the wireless computing devices that make up the wireless LAN.

One popular incarnation of wireless networking technology involves the wireless-Ethernet standard known as IEEE 802.11. Of the various 802.11 compliant solutions, Wi-Fi may be the most well known. Wi-Fi (which may be implemented as “802.11b,” “802.11g,” and/or “802.11a”) has emerged as a dominant standard for wireless LANs (WLANs) and has enjoyed a substantial increase in the number of individuals using it to create home networks.

### BRIEF DESCRIPTION OF THE DRAWINGS

It will be appreciated that for simplicity and clarity of illustration, elements illustrated in the Figures have not necessarily been drawn to scale. For example, the dimensions of some of the elements may be exaggerated relative to other elements. Embodiments incorporating teachings of the present disclosure are shown and described with respect to the drawings presented herein, in which:

FIG. 1 presents a block diagram of a networked system that incorporates teachings of the present disclosure;

FIG. 2 shows a flow diagram for a technique that may be used to implement teachings of the present disclosure;

FIG. 3 presents a simplified block diagram for a wireless networking system that incorporates teachings of the present disclosure; and

FIG. 4 shows a flow diagram for a technique that may be used to implement teachings of the present disclosure.

### DETAILED DESCRIPTION OF THE DRAWINGS

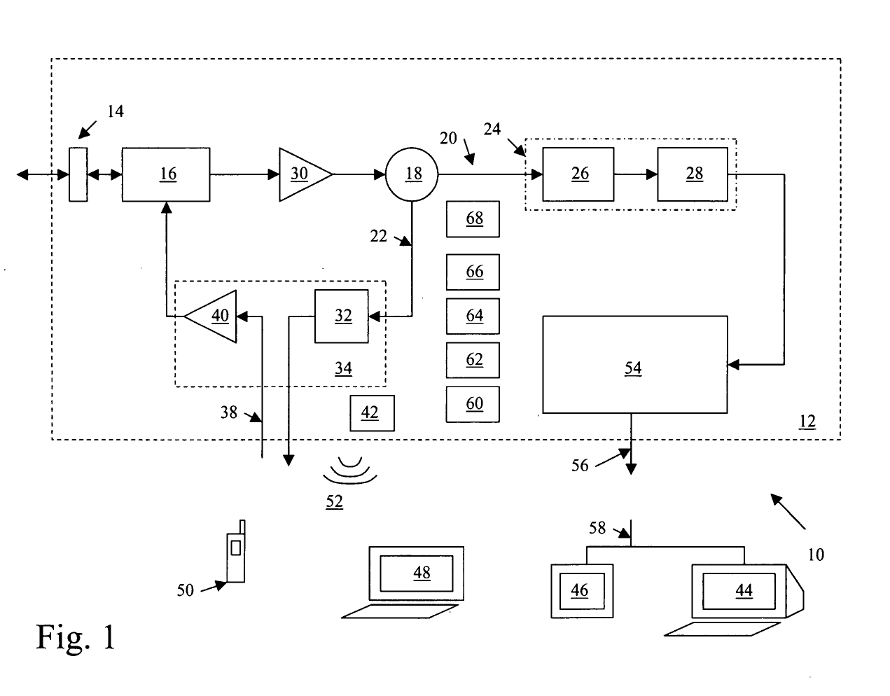

As mentioned above, FIG. 1 presents a block diagram of a system 10 that incorporates teachings of the present disclosure. As depicted, system 10 includes an integrated tuning device 12, which may be a Set-Top Box (STB), a personal computer (PC) executing a video application, a wireless local area networking (WLAN) hub, or some other integrated electronic device. As depicted, device 12 includes a network interface adapter 14 providing at least a portion of a communication path interconnecting device 12 to a wide area communication network, which may include a cable network, a direct broadcast satellite (DBS) system, a telecommunication network, and/or some other network capable of communicating information to device 12.

In operation, adapter 14 may receive a signal representing several different types of information including video information streams, telephony-related information, data transmissions, and/or other types of information. For example, a cable service provider may broadcast a signal to each of its customers that represents hundreds of video channels and several more broadcast audio channels. Satellite television providers, like DBS providers, may provide even more channels. A signal received by adapter 14 may include these types of signals in combination with other less universally distributed signals.

In some embodiments of device 12, adapter 14 may perform front-end subsystem functions like signal reception, demodulation, error correction, signal encoding, and/or other signal manipulations. Many of these subsystem functions may be provider specific. For example, a signal coming from a cable head end may require front end processing that is substantially different than the processing performed on a DBS signal.

Adapter 14 may output a processed signal to diplexer 16. As depicted, device 12 may be capable of performing several high-end functions. For example, in addition to performing some STB-like functions, device 12 may also effectively function as a multimedia desktop computer that runs a variety of advanced services such as videoconferencing, home networking, Internet Protocol telephony, Video on Demand (VoD), high-speed Internet Television, personal video recording, and/or others. Diplexer 16 may facilitate some of these services by distinguish between upstream and downstream communication flow. In some embodiments, different types of traffic may be carried in different frequency band. For example, data traffic may be carried in one band while voice telephony traffic may be carried in another. Similarly, upstream traffic may be carried in a defined frequency range that is different than the defined frequency range of downstream traffic. As such, diplexer 16 may be able to separate traffic types by reference to the frequency of the signals.

Diplexer 16 may output a downstream multiplexed signal to a splitter 18, which may be passive in operation. In some embodiments, splitter 18 may passively split a signal into an intermediate signal 20 and a downstream data stream 22. Signal 20 may feed an output module 24. As shown, output module 24 may include a decoder 26 and a modulator 28. Because splitting a signal may degrade the noise figure (NF) of a system, a low noise, high linearity amplifier 30 may be added to device 12 upstream of splitter 18. In some embodiments, amplifier 30 may be low noise and high linearity so as not to compromise what is downstream in the signal chain.

As shown, splitter 18 may also pass a data stream 22 through tuner 32 to a modem 34, which may be integral to or separate from device 12. Modem 34 may be a cable modem supporting a DOCSIS standard, a dial-up modem, a wireless modem, a satellite modem, and/or an xDSL modem. In some embodiments, tuner 32 may alter stream 22 and output a signal in a form or modulation schema acceptable to modem 34. On the upstream side, an outgoing signal 38 may pass through amplifier 40 and into diplexer 16 for delivery to a broader network, like the Public Internet.

In some embodiments, device 12 may include WLAN module 42. Module 42 may operate as a WLAN hub and my support communication via a 900 MHz communication signal similar to those employed by cordless telephones, an 802.11(x) communication protocol, a Bluetooth communication protocol, or some other WLAN communication technique. When operating as a WLAN hub, module 42 may effectively allow device 12 to act as a wireless home networking hub. As such, other electronic devices in the home, like desktop computer 44, television 46, laptop 48, and wireless telephone 50 may be able to enjoy Internet connectivity via device 12 and wireless link 52.

Device 12 may also include a premise network interface 54, which may output signal 56 with information streams representing, among other things, broadcast channel programs to premise network element 58. In some embodiments, network interface 54 may also support modem 34 and/or allow for two-way communication across premise network element 58. As depicted, device 12 also includes a local memory 60, which may store, among other things, a file having computer-readable instructions to direct a processor of a wireless telephone like telephone 50 to recognize the accessibility of a WLAN hub like module 42. The file may have been received by device 12 via adapter 14 and may, in some embodiments, be wirelessly-communicated to telephone 50.

The computer-readable instructions may also work with and recognize that a user is creating a wireless messaging service message configured for communication from wireless telephone 50 to a wide area wireless network element like a cellular tower. The message may be for example, a Short Messaging Service (SMS) message, an Enhanced Messaging Service (EMS) message, and/or a Multi-media Messaging Service (MMS) message. Whatever the format, the computer-readable instructions may allow telephone 50 to re-route the message to a WLAN hub, which may be module 42. As such, the message may be sent via device 12 as opposed to via a wide area wireless data service like General Packet Radio Service (GPRS). In effect, this may allow the user to save considerable money as some wireless messaging services are based on a relatively expensive cost per message billing plan.

Memory 60 may also maintain a messaging address for one or more subscriber-related devices. These addresses may be programmed into memory 60 and may, in some cases, be readily updateable. In an embodiment where device 12 “knows” a messaging address for a subscriber, messaging engine 62 may initiate communication of message containing call activity information to the messaging address. Call activity information may represent, for example, Caller ID information for an incoming call, and the message may be sent using several different services such as electronic mail, mobile alerts, Instant Messaging, Short Messaging Service, Enhanced Messaging Service, and/or Multi-media Messaging Service.

In some embodiments, device 12 may also include enhanced presence awareness features. A presence detection engine 64 may recognize when a subscriber is at home, at the office, or some other defined area near device 12. The subscriber may want to send an SMS message from wireless telephone 50. Wireless telephone 50 may be an SMS enabled device. Telephone 50 may also be an Enhanced Messaging Service (EMS) enabled device, a Multi-media Messaging Service (MMS) enabled device, and/or an Instant Messaging (IM) enabled device. As such, telephone 50 may be embodied in a data-capable device, a cellular telephone, a smartphone, a PDA, or some other wireless-enabled communication device.

An SMS or Short Message Service offering may allow the transmission of short text messages to and from a mobile phone, fax machine, and/or IP address. SMS Messages may be approximately 160 alphanumeric characters and may contain little or no images or graphics. An MMS or Multi-media Messaging Service offering may involve a store-and-forward technique of transmitting graphics, video clips, sound files and short text messages over wireless networks using a protocol like Wireless Access Protocol (WAP). With SMS, EMS, MMS and other services, a carrier may deploy network-based assets to implement the offerings.

With an MMS offering, the presentation characteristics of a message may be coded into a presentation file so that the images, sounds, and/or text are displayed at the recipient device as intended by the sender. To a subscriber, SMS, EMS, and MMS may operate in a similar manner. To an operator, MMS may be slightly different and may use its own standardized presentation protocol, Synchronized Multimedia Integration Language (SMIL).

SMIL operates as a descriptive or markup language that performs functions similar to those performed by HTML on the Web. SMIL provides a set of rules for integrating multimedia elements of text, images, audio, and video sequences in a multimedia message so that they can be transported across a network. SMIL may also control the display and layout of an MMS presentation, helping to ensure that the presentation of the multimedia elements may be delivered and presented in accordance with the sender's intent.

The elements of a specific multimedia message may be combined in a so-called SMIL container before transmission. This container may be linked to or encapsulated in a WAP file, which may provide information like sender and recipient addresses. In operation, a WAP portal may “see” the MMS message as it routes to a messaging service center of an operator offering or supporting the messaging service.

In some implementations of system 10, a user may elect to send an SMS message, an EMS message, an MMS message, an IM message, an electronic mail message, and/or other some message from telephone 50. When the user is away from device 12, these messages may be addressed to an intended recipient and communicated from telephone 50 to a wide-area wireless network node like a cellular tower. When presence detection engine 64 recognizes that the user is near device 12, the messages may be communicated to module 42 and routed to the intended recipient via device 12.

As such, the user may be able to effectively send a wide area wireless data message from a location that may have limited or low quality cellular coverage. In an embodiment where device 12 connects to a wired network like the PSTN or a cable network, the user may be able to effectively send a wide area wireless data message across a combined local area wireless network and wired network. However sent, a message may be delivered to its intended recipient and the intended recipient may be notified of the message.

With wirelessly connected recipients, the notification may be provided in a WAP format and may contain the “name” of the sender, information about the message content, and a Web address (URL) needed to call up and retrieve the message. The Web address may be associated with a communication service provider network element, a unified mailbox associated with an intranet, extranet and/or the Public Internet 48, or some other network-connected resource. From the recipient perspective, a message may download in response to a retrieval command, which may be initiated in several ways. For example, a user may press a button on his or her telephone or interact with a graphical user interface (GUI) presented on a display associated with his or her computer.

With such advanced features, device 12 may also include a Web interface engine 66. Engine 66 may allow remote web-based administration of device 12. Device 12 may also include local administration features. As shown, graphical user interface (GUI) engine 68 may be capable of initiating presentation of a GUI on a television display communicatively coupled to premise network 58. The GUI may also be presented in connection with a Web browser and a Web browsing session of a user. Similarly, an administrator may be presented with an administration screen. The screen may also allow for simplified configuration of the features associated with device 12. The administration screen may also allow a user to configure or administer a home network that includes device 12.

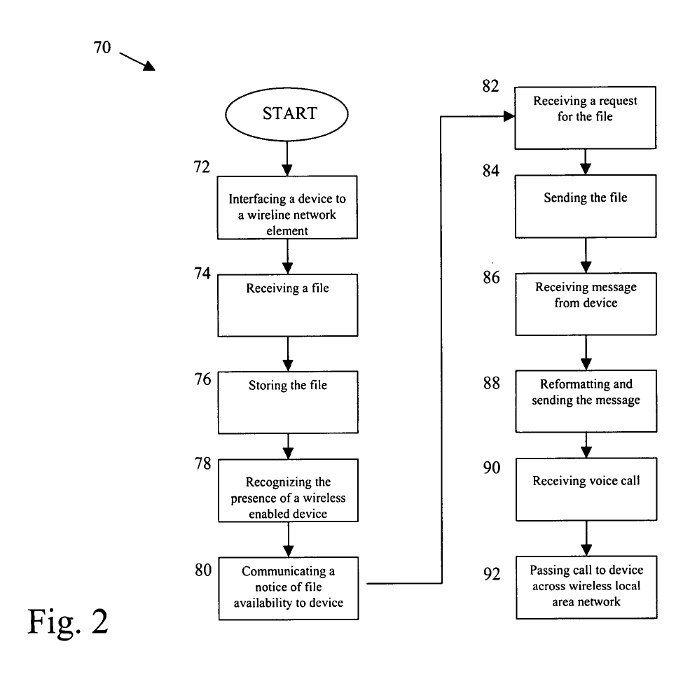

As mentioned above, FIG. 2 shows a flow diagram for a technique 70 that may be used to implement teachings of the present disclosure. Technique 70 may begin at step 72 where a device having wireless LAN capabilities may be interfaced to a wireline network element. For example, a WLAN hub may be supported by a broadband backhaul provided by a modem like an xDSL modem or a cable modem. As such, the backhaul may allow the WLAN hub to communicate information to a network like the Public Internet via a wireline network like a cable network or the PSTN.

At step 74, the device may receive a file having computer-readable instructions to direct wireless-enabled communication devices to send wireless messaging service messages to the device instead of directly to a wide area wireless network node. The device may store the file in a local memory at step 76. At step 78, the device or one of its components may recognize that a wireless-enabled device has entered a coverage area of the WLAN. The wireless-enabled device (WED) may have both a wide-area wireless transceiver and a local area wireless transceiver. At step 80, the wireline connected device may send a notice to the WED—informing the WED that a file is available that may allow the WED to send wireless messaging service messages to the wireline connected device using a short-range wireless communication protocol. In practice, messages may be delivered to their intended recipients via the wireline network as opposed to delivery via a wireless wide area network.

At step 82, the device may receive a signal indicating that the WED would like to receive the file, and at step 84, the file may be sent. The WED may receive and launch the file, which may be in a JAVA or some other format. At step 86, the device may receive a wireless messaging service message from the WED. The message may, for example, appear as an SMS message, an EMS message, or an MMS message, addressed to an intended recipient. The device may initiate sending of the message during step 86. In some embodiments, the message may be routed via the wireline network to a Messaging Service Center (MSC) associated with a wireless communication service supporting the WED for eventual delivery to the intended recipient. In some implementations, the MSC may support or facilitate session initiation protocol (SIP).

SIP offers a text-based description protocol that allows two systems to describe a media stream, which may be for example voice traffic, that needs to get from point A to point B. The description itself may include information relating to authentication, caller ID, media stream parameters, and/or other information for supporting a call between the two endpoints.

In operation, a call intended for a dialed number may be received in network on a channel. A call receipt process may begin in order to learn what to do and where to “send” the received call. For example, a dialed number, or some other type of device address may be translated into a variable for use during call processing activities. The processing activities may include, for example, a number of match tests performed against the variable. These match tests may be executed until a match is found.

A found match may have several allocated operators. These operations may have a priority indicator or number telling a processing server in what order the server should attempt to execute the applications associated with the found match. If, for example, there are three operations associated with a given match, a SIP-based system may prioritize the operations by giving them respective priority values of 1, 2, and 3—telling the processing server to try the priority 1 operation first.

In one embodiment, if an inbound call is directed to a dialed number, 345-6789, a variable value of 6789 may be assigned to the dialed number. The variable may then be compared against a list of match statements to determine how to handle the call. If the priority 1 application for the match is “Dial,” this application may be performed.

The Dial application may direct the processing server to ring a remote channel and then connect the two channels together if the call is answered. The Dial application may also have additional capabilities. As mentioned above, if a Dial application gets an answer on the remote channel, the two callers may be bridged together and the call may proceed. After the call, one or both parties to the call may elect to hang up. When this occurs, the Dial routine may exit with a non-zero status, and the priority list may stop executing because the call is terminated.

In some cases, there may be no answer to the call launched by the Dial application. If, for example, the Dial application rings a remote phone for some set amount of time, which may be specified in a Dial statement, and there is no answer, Dial may exit and the next priority application may be executed. In many cases, the next application may be a voicemail application, and the caller may hear an “unavailable” greeting for the called party.

If the Dial application gets a “busy” answer back from the remote phone, or the remote phone is not on-line, the Dial application may apply an adder value to the existing priority value—allowing the processing server to bypass the level 2 priority and route directly to a level 3 or higher priority application. For example, the caller may be routed to a “busy” greeting for the called party.

A service provider may elect to provide SIP-like functionality using several different architectures. Depending upon implementation detail, some SIP components may be combination modules or discrete modules, implemented in software, hardware, and/or firmware. From a high level, many SIP system components may be acting as or executing user agents and/or SIP servers.

For example, telephony devices may include user agents (UAs), which may be a combination of a user agent client (UAC) and a user agent server (UAS). In operation, a UAC entity may be permitted to create an original request, and a UAS may represent one or more server types capable of receiving requests and sending back responses. A SIP UA may be implemented in hardware such as an IP phone or a gateway component or in software such as a softphone application running on a computing platform.

Various SIP UAs may connect to one another with the help of a collection of SIP servers. In many cases, these SIP servers may be executing on centralized hosts of a distributed communication network. Again depending upon implementation detail, a large SIP system may include several different kinds of servers such as Location Servers, Proxy Servers, Redirect Servers, and Registrar Servers.

In operation, a Location Server may be used by a Redirect server or a Proxy Server to obtain information about a called party's location. A Proxy Server may represent an intermediary program that acts as both a server and a client for the purpose of making requests on behalf of other clients. Such requests may be serviced internally or transferred to other servers. In some cases, a Proxy Server may interpret and then rewrite a request message before forwarding it. A Redirect Server may accept a SIP request, map the address into zero or more new addresses, and return these addresses to the client. In some cases, the Redirect Server may be designed such that it does not accept calls but does generate SIP responses that instruct a UAC to contact another SIP entity. As the name implies, a Registrar Server may accept REGISTER requests and may be co-located with a Proxy or Redirect server to offer these servers some level of location server-like assistance.

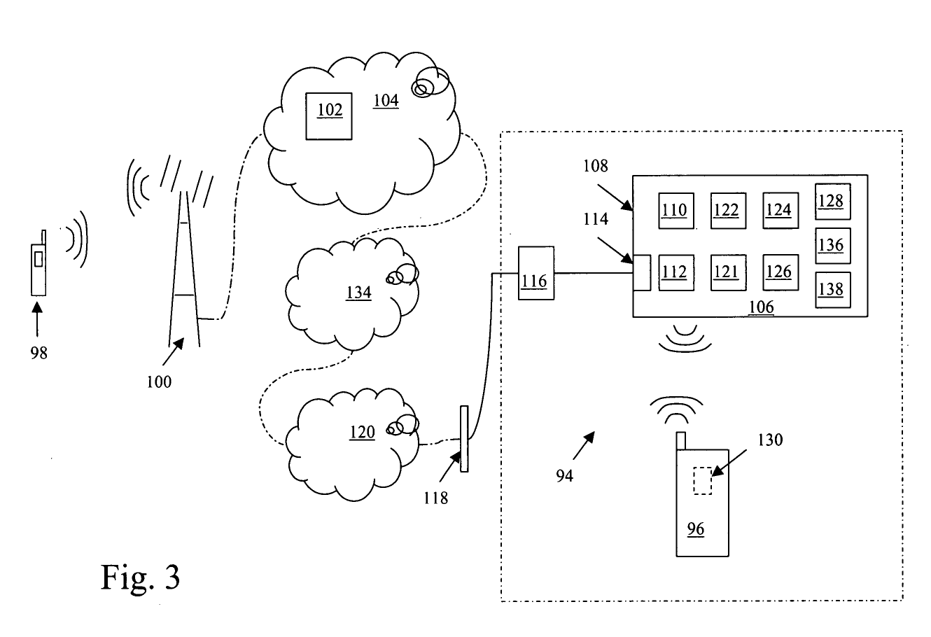

At step 90, the network-connected device may receive a SIP-based indication of an incoming telephone call intended for the WED or a subscriber associated with the WED. The voice call may have a packetized format and may be, for example, a VoIP call. At step, 92, the network-connected device may pass the voice call to the WED via the WLAN. Technique 70 may be better understood in connection with a system like the one depicted in FIG. 3.

As mentioned above, FIG. 3 presents a simplified block diagram for a wireless networking system 94 that incorporates teachings of the present disclosure. In operation of system 94, a user of a wireless telephone 96 or some other wireless enabled communication device may want to send an SMS message to a user of device 98. The SMS message may be sent directly to a wide area wireless network element such as a cellular tower like cellular tower 100. For example, if device 98 initiated sending of an SMS message, the message would likely be sent using GSM technology to cellular tower 100 and on to a messaging service center (MSC) element 102 of wide area wireless network 104 for eventual delivery to an intended recipient. Depending on implementation detail, MSC element 102 maybe executing a SIP server.

In system 94, a computing device 106 may include a housing component 108 that at least partially defines an enclosure. Within the enclosure, device 106 may have a memory 110 storing a WLAN messaging file and a WLAN module 112. The messaging file may include an over the air downloadable Java application having instructions that facilitate WLAN delivery of SMS, EMS, and MMS messages. For example, the file may include computer-readable data to direct a processor of a wireless-enabled communication device to recognize the accessibility of module 112, to recognize that a user is creating a wireless messaging service message intended for communication from the wireless-enabled communication device to a wide area wireless network, and to re-route the message to module 112.

In operation, module 112 may receive an SMS-like message and pass it along for eventual delivery to the intended recipient. Module 112 may also allow computing device 106 to act as a WLAN hub within coverage area 113 and may couple through an interface 114 to a premise network wall plate 116 and on to a node 118 of a wireline network 120, which may be executing a SIP server. In some embodiments, wall plate 116 may facilitate connection to a coaxial cable network. In other embodiments, wall plate 116 may include a Category 5 connection, a fiber connection, an RJ-11 connection to a twisted pair network, and/or some other connector and network combination. As mentioned above, a wireline network may include a cable network, a PSTN, or some other wired network. Whatever the network type, node 118 may be network dependent. For example, node 118 may be associated with a Digital Subscriber Line Access Multiplexer or cable head end equipment. In an embodiment in which wireline network 120 supports two-way data traffic with device 106, device 106 may also include a modem 121 to facilitate the flow of data traffic.

In addition to the above-described components, device 106 may also include a video stream decoder 122, an enhanced service engine 124, and a processor 126. Decoder 122 may allow device 106 to support STB-like functions. For example, if node 118 is associated with cable head end equipment, device 106 may receive encoded broadcast video streams. Decoder 122 may decode a select channel and facilitate presentation of that channel on a given television. Enhanced service engine 124 may allow device 106 to support features like VoIP, video conferencing, alarm system functionality, and/or others.

As mentioned above, device 106 may pass along SMS-like messages to their intended recipients. As such, device 106 may include a message-forwarding engine 128, which may include a SIP UA, and which may be configured to output information representing the wireless messaging service message via interface 114 to wireline network 120. In practice, a user of telephone 96 may elect to send device 98 a wireless messaging service message. The message may have, for example, an SMS, EMS, MMS, IM, and/or other format. If the user has downloaded the above-discussed WLAN messaging file, a processor 130 of telephone 96 may elect or allow the user to elect to send the wireless messaging service message to device 106 via module 112 as opposed to sending the message to a cellular tower or other wide area wireless network element. Forwarding engine 128 may then facilitate and/or initiate communication of the message to wireline network 120 for delivery to MSC element 102 via data network 134, which may be the Public Internet. Data network 134 may effectively interconnect networks 104 and 120 and may allow for packet-switched communication of information.

Device 106 may also support remote monitoring of call activity. For example, device 106 may include a triggering engine 136 that recognizes when a voice call is communicated to or from the premise. In response this recognition, triggering engine 136 may output a signal recognized by a notification engine 138. Notification engine may then initiate sending of a notification message to a subscriber. The notification message may “tell” the subscriber about the call activity at the premise. The message may include call activity information and may be sent using one or more of several different messaging mechanisms. These mechanisms may include, for example, an electronic mail message, a browser pop-up, a mobile alerts, an Instant Message (IM), a Short Messaging Service message (SMS), an Enhanced Messaging Service message (EMS), and/or a Multi-media Messaging Service message (MMS). The message may be addressed to a messaging address stored in memory 110, and the address may identify a device associated with the subscriber. In various embodiments, the wireless phone or wireless communication device may take various forms including personal digital assistants with built in communications circuitries, wireless telephones, cellular telephones, mobile telephones, and other wireless devices. Moreover, many of the devices, software, and/or pieces of equipment, referenced herein, may be SIP-enabled and may act, for example as a SIP UA.

The various embodiments of the present invention involve the placing of telephone calls. These calls may comprise voice communications transmitted, either alone or in combination with data, video, or other messaging via either a public switched telephone network, a public or private wireless communication network, a private telephone network, via digital subscriber line access to a computer or telephony network, cable-television-based access to a computer or telephony network, satellite-based access to a computer or telephony network, or any combination thereof.

Based upon the herein-disclosed high-level description, one or more computer programs to direct one or more computers to perform the method is within the skill of a routineer in the art of telecommunications.

Embodiments of the herein-disclosed method may be directed by computer-readable instructions encoded on a computer-readable medium. The contents of the computer-readable medium cause at least one computer to perform the herein-disclosed acts. For this purpose, at least one computer processor is responsive to the contents of the computer-readable medium. Examples of the computer-readable medium include, but are not limited to, a computer-readable storage medium and a computer-readable communication medium. Examples of a computer-readable storage medium include, but are not limited to, an optical storage medium, an electronic storage medium, and a magnetic storage medium. The computer-readable storage medium may include stored data which encode computer program code and/or other computer-readable instructions. Examples of a computer-readable communication medium include, but are not limited to, an optical communication medium, an electronic communication medium, and an electromagnetic communication medium. The contents of the computer-readable communication medium may include one or more waveforms which encode computer data such as computer program code and/or other computer-readable instructions.

Triggering engine 136 and notification engine 138 may be configured to notify a subscriber using different messaging mechanisms, at different subscriber-associated devices, and/or upon the occurrence of different events. Some subscribers may want to know when a 911 call has been placed from a telephone station associated with a given telephone number. Perhaps a subscriber has an elderly relative living at the subscriber's home. If the relative needs help when the subscriber is at work, the relative may dial 911. In some embodiments, subscribers may simply want to know that they recently missed a telephone or data call.

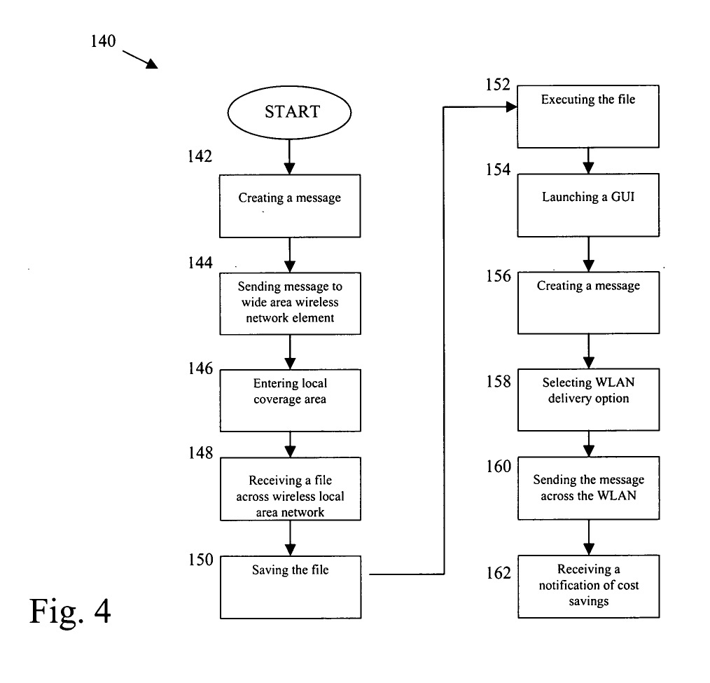

As mentioned above, FIG. 4 shows a flow diagram for a technique 140 that may be used to implement teachings of the present disclosure. At step 142, a user may create a wireless messaging service message addressed to an intended recipient, and at step 144 the user may initiate sending of the message to the intended recipient by communicating the message to a wide area wireless network element.

At step 146, the user may bring a communication device within the coverage area of a WLAN hub. At step 148, the user may receive a file with instructions that allow sending of wide area wireless messaging service message via a local area network communication protocol. At step 150, the user may save the file on the communication device and may execute the file at step 152 to install or implement the instructions. At step 154, the user may access a graphical user interface (GUI) that allows for creation of a wide area wireless messaging service message, which may be an SMS, EMS, MMS, IM, or other message. At step 156, the user may begin creating the message and may be given an option of WWAN or WLAN delivery. At step 158, the user may select WLAN delivery, and at step 160, the message may be communicated via the WLAN.

The message may then be communicated across a wireline network to an MSC of a wireless service provider. The MSC may then effectuate delivery of the message to its intended recipient. In practice, wireline delivery of a wireless data message may cost the user less money. For example, a wireless carrier may charge a subscriber some amount of money per message or per bit. By communicating the message via a WLAN and wireline network, the user may avoid the wireless carrier charges. At step, 162, a user may be notified of the cost savings associated with the wireline delivery option.

Though technique 140 is described from the perspective of a user, many of the steps may be performed by the user's communication device. The methods and systems described herein provide for an adaptable implementation. Although certain embodiments have been described using specific examples or from specific perspectives, it will be apparent to those skilled in the art that the invention is not limited to these few examples. Additionally, various types of wireless transceivers, transmitters, receivers, and protocols are currently available which could be suitable for use in employing the methods as taught herein. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

What is claimed is:

1. A home networking system comprising:
a housing component at least partially defining an enclosure;
a processor located within the enclosure;
an interface operable to communicatively couple with an element of a premise network to provide at least a portion of a communication link between the processor and a node of a wireline network;
a wireless local area networking module communicatively coupled to a memory and configured to communicate within a local coverage area using a proximal wireless protocol;
the memory storing a messaging file comprising instructions to direct a wireless telephone processor to send a wireless messaging service message configured for delivery via a wide area wireless network to the wireless local area networking module using the proximal wireless protocol; and
a message forwarding engine configured to output information representing the wireless messaging service message via the interface to the wireline network.

2. The system of claim 1, further comprising:
a triggering engine operable to recognize a voice call communicated via the premise network and further operable to output a signal in response to recognizing the voice call; and
a notification engine responsive to the signal and operable to initiate sending a notification message addressed to a messaging address via the interface, the messaging address identifying a wireless-enabled device.

3. The system of claim 1, wherein the wireless messaging service message is configured for delivery using a wide area wireless messaging service selected from the group consisting of electronic mail, IM, SMS, EMS, and MMS.

4. The system of claim 1, wherein the node of the wireline network comprises a piece of cable head end equipment, further comprising a video stream decoder communicatively coupled to the interface and operable to decode a signal communicated from the node via the interface.

5. The system of claim 1, further comprising a modem device communicatively coupled to the interface, the modem device selected from the group consisting of a cable modem, a dial-up modem, a wireless modem, a satellite modem, and an xDSL modem.

6. The system of claim 1, further comprising an enhanced service engine operable to facilitate deployment of an enhanced service selected from the group consisting of a videoconferencing service, a home networking service, an Internet Protocol telephony service, a Video on Demand (VoD) service, a high-speed Internet Television service, and a personal video recording service.

7. The system of claim 1, wherein the messaging file comprises an over the air downloadable Java application.

8. A computer-readable medium having computer-readable data to direct a processor of a wireless-enabled communication device to recognize accessibility of WLAN hub via a local coverage area, to identify a wireless messaging service message intended for communication from the wireless-enabled communication device to a wide area wireless network, and to re-route the message to the WLAN hub.

9. A communication networking method comprising:
interfacing a device having a short-range wireless transceiver to a wireline network element;
receiving via the short-range wireless transceiver a wide area wireless messaging service message addressed to a recipient; and
initiating communication of information representing the message to the recipient via the wireline network element.

10. The method of claim 9, further comprising:
storing a file comprising executable instructions for sending a given wide area wireless messaging service message via a short-range wireless networking protocol; and
wirelessly communicating the file to a wireless-enable communication device.

11. The method of claim 9, further comprising receiving an incoming signal that comprises information representing a plurality of broadcast video streams.

12. The method of claim 9, wherein the short-range wireless transceiver is operable to communicate using an 802.11(x) compliant protocol.

13. The method of claim 9, further comprising modifying the message for delivery via the wireline network element such that a received message delivered to the recipient appears as an incoming messaging delivered by a service selected from the group consisting of an electronic mail service, an IM service, an SMS, an EMS, and an MMS.

14. The method of claim 9, further comprising:
receiving via the wireline network element a file comprising executable instructions for sending a given wide area wireless messaging service message via a short-range wireless networking protocol;
storing the file; and
wirelessly communicating the file to a wireless-enable communication device.

15. The method of claim 14, further comprising:
communicating a notification to the wireless-enabled communication device indicating availability of the file; and
receiving a request for the file from the wireless-enabled communication device.

16. The method of claim 9, wherein the wireline network element comprises a cable modem.

17. The method of claim 9, wherein the wireline network element comprises an xDSL modem.

18. The method of claim 9, further comprising:
receiving a voice call via the wireline network element;
recognizing that a wireless-enabled communication device is within a coverage area of the short-range wireless transceiver; and
allowing the wireless-enabled device to participate in the voice call.

19. A communication method comprising:
creating a first message for delivery by a messaging service selected from a group consisting of an SMS, an EMS, and an MMS;
sending the message with a wide area wireless transceiver of a wireless telephone;
creating a second message for delivery by a messaging service selected from the group; and
sending the second message with a local area transceiver of the wireless telephone.

20. The method of claim 19, further comprising:
initiating presentation of a graphical user interface (GUI) on a display of the wireless telephone, the GUI including an icon for launching a message creation engine;
recognizing a desire to create the second messaging service message;
presenting a wireline delivery option; and
receiving a signal indicating selection of the wireline delivery option, wherein the wireline delivery option comprises sending the second message with the local area transceiver.

21. The method of claim 19, further comprising:
receiving an incoming message with an attached file;
saving the file to a local memory; and
executing the file to create a message delivery option that employs the local area transceiver of the wireless telephone to send the second message.

22. The method of claim 21, further comprising receiving the incoming message via the local area transceiver.

23. A communication service method comprising:
recognizing that a wireless telephone is within a coverage area of a wireless local area networking hub; and
allowing the wireless telephone to send a message selected from a group consisting of an SMS message, an EMS message, and an MMS message to an intended recipient via the wireless local area networking hub.

24. The method of claim 23, further comprising:
providing a wired broadband backhaul service to a subscriber associated with the wireless telephone; and
communicating the message to a messaging service center at no additional charge to the subscriber.

25. The method of claim 24, further comprising making a file available to the subscriber, the file comprising computer-readable instructions to direct a processor of the wireless telephone to recognize accessibility of a WLAN hub via a local coverage area, to identify a wireless messaging service message configured for communication from the wireless telephone to a wide area wireless network, and to re-route the message to the WLAN hub.

26. The system of claim 24, further comprising indicating to the subscriber on a bill an amount saved by communicating the message from the wireless telephone to the wireless local area networking hub as compared to delivery from the wireless telephone to a wide area wireless network element.
